(19) United States
(12) Patent Application Publication
(10) Pub. No.: US 2018/0265998 A1
(43) Pub. Date: Sep. 20, 2018

(54) MULTI-MATERIAL LIGHT-DIRECTED ELECTROPHORETIC DEPOSITION AND ELECTROPLATING OVER LARGE AREAS USING MOVEABLE PROJECTED IMAGES AND/OR ELECTRODES

(71) Applicant: Lawrence Livermore National Security, LLC, Livermore, CA (US)

(72) Inventor: Jeronimo Mora, Oakland, CA (US)

(21) Appl. No.: 15/981,780

(22) Filed: May 16, 2018

Related U.S. Application Data
(62) Division of application No. 15/462,610, filed on Mar. 17, 2017.

(51) Int. Cl. C25D 5/02; B33Y 50/02; B33Y 30/00; B33Y 10/00; C25D 5/10; C25D 13/24; C25D 15/02; C25D 21/18

(52) U.S. Cl. CPC C25D 5/024; B33Y 50/02; B33Y 30/00; B33Y 10/00; C25D 21/18; C25D 5/10; C25D 13/24; C25D 15/02

(57) ABSTRACT

According to one embodiment, a method for fabricating a 3D model of different materials includes positioning a moveable deposition electrode at a distance from a photoconductive electrode, directing light onto the photoconductive electrode in a first pattern while simultaneously applying a voltage differential across the electrodes. Particles from a solution are deposited to form a first layer on the deposition electrode according to the first pattern. The method repeats, for a given number N of layers of the 3D model, the following operations N-1 times: changing or maintaining a composition of the solution, moving the moveable deposition electrode in a z direction in steps about equal to a thickness of each deposited layer, directing light onto the photoconductive electrode in another pattern while simultaneously applying another voltage differential across the electrodes. Particles from the solution are deposited to form another layer above the deposition electrode according to another pattern.

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to producing fine featured patterned three dimensional parts, and more particularly, this invention relates to using three dimensional electrophoretic deposition and electroplating to form fine featured patterned three dimensional parts over a large area.

### BACKGROUND

The electrophoretic deposition (EPD) process utilizes electric fields to deposit charged nanoparticles from a solution onto a substrate. The material set for electrophoretic deposition is vast and includes ceramics, metal, plastics, bacteria, etc. Electroplating is a similar process that utilizes electric fields to deposit metal ions from a solution onto a substrate by an electrochemical reaction. Both processes have been used industrially to create thin films.

There is renewed interest in using electrophoretic deposition in combination with electroplating as an additive manufacturing technique to fabricate three dimensional (3D) structures. However, typical EPD processes are limited in that they are only capable of forming planar, homogenous structures.

### SUMMARY

According to one embodiment, a method for fabricating a 3D model of different materials includes positioning a moveable deposition electrode at a pre-defined distance from a counter electrode, where the deposition electrode and the counter electrode are positioned in a bath and are oriented opposite from one another. The counter electrode is a photoconductive electrode. The method further includes directing light onto the photoconductive electrode in a pre-defined first pattern while simultaneously applying a voltage differential across the photoconductive electrode and the deposition electrode, whereby particles from a solution in the bath are deposited to form a first layer on the deposition electrode according to the pre-defined first pattern. The method repeats, for a given number N of layers of the 3D model, the following operations N-1 times: changing or maintaining a composition of the solution in the bath, moving the moveable deposition electrode in a z direction in steps about equal to a thickness of each deposited layer after deposition of the respective layer such that a pre-defined distance from the photoconductive electrode is maintained and a deposition of each subsequent layer occurs substantially at the pre-defined distance from the photoconductive electrode, directing light onto the photoconductive electrode in another pre-defined pattern while simultaneously applying another voltage differential across the photoconductive electrode and the deposition electrode, whereby particles from the solution in the bath are deposited to form another layer above the deposition electrode according to another pre-defined pattern.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a schematic drawing of a system, according to one embodiment of the presently disclosed inventive concepts.

FIGS. 2A-2C are simplified schematic drawings of the formation of 3D layers by EPD, according to one embodiment of the presently disclosed inventive concepts.

FIG. 3 is a schematic drawing of a system, according to one embodiment of the presently disclosed inventive concepts.

FIG. 4 is a schematic drawing of a system, according to one embodiment of the presently disclosed inventive concepts.

FIG. 5 is a schematic drawing of a system, according to one embodiment of the presently disclosed inventive concepts.

FIG. 6 is a schematic drawing of a system, according to one embodiment of the presently disclosed inventive concepts.

FIG. 7 is a flowchart of a method, according to one embodiment of the presently disclosed inventive concepts.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of light-directed EPD and electroplating over a large area and/or related systems and methods.

In one general embodiment, a system includes a deposition electrode, where the deposition electrode is configured to move in a z direction and the deposition electrode is configured to move during deposition, a counter electrode, where the counter electrode is a photoconductive electrode, a mechanism for directing a light onto the photoconductive electrode, a chamber, and a power source for applying a voltage differential across the electrodes. In addition, the deposition electrode and the counter electrode are positioned in the chamber and are oriented opposite from one another. Moreover, the mechanism for direction light is configured to move the light in an x direction and/or a y direction, where the x direction is oriented perpendicular to the y direction and x-y directions are in a plane that is perpendicular to the z direction.

In another general embodiment, a method for fabricating a 3D model of different materials includes positioning a moveable deposition electrode at a pre-defined distance from a counter electrode, where the deposition electrode and the counter electrode are positioned in a bath and are oriented opposite from one another. The counter electrode is a photoconductive electrode. The method further includes directing light onto the photoconductive electrode in a pre-defined first pattern while simultaneously applying a voltage differential across the photoconductive electrode and the deposition electrode, whereby particles from a solution in the bath are deposited to form a first layer on the deposition electrode according to the pre-defined first pattern. The method repeats, for a given number N of layers of the 3D model, the following operations N-1 times: changing or maintaining a composition of the solution in the bath, moving the moveable deposition electrode in a z direction in steps about equal to a thickness of each deposited layer after deposition of the respective layer such that a pre-defined distance from the photoconductive electrode is maintained and a deposition of each subsequent layer occurs substantially at the pre-defined distance from the photoconductive electrode, directing light onto the photoconductive electrode in another pre-defined pattern while simultaneously applying another voltage differential across the photoconductive electrode and the deposition electrode, whereby particles from the solution in the bath are deposited to form another layer above the deposition electrode according to another pre-defined pattern.

In yet another general embodiment, a system includes a deposition electrode configured to move in an x direction and/or a y direction, where the x direction is oriented perpendicular to the y direction and x-y directions are in a plane that is perpendicular to a z direction, and a counter electrode, where the counter electrode is a photoconductive electrode and fixed in position in the chamber. The system also includes a mechanism for directing a light onto the photoconductive electrode, a chamber, and a power source for applying a voltage differential across the electrodes. In addition, the deposition electrode is configured to move during deposition. The deposition electrode and the counter electrode are positioned in a chamber and are oriented opposite from one another. Moreover, the mechanism for directing light is configured to direct light to the fixed photoconductive electrode.

Typically, EPD has been used for forming coatings on surfaces using organic solvents. Recent nanomaterial studies have demonstrated that aqueous solution-based (water-based) EPD is capable of forming structures with small feature sizes. In addition, EPD and electroplating may be performed using a wide variety of charged nanoparticles, such as oxides, metals, polymers, semiconductors, diamond, etc. However, typical EPD and electroplating processes are limited in application for forming structures in that they are only capable of forming planar, homogenous structures in a restricted area. The size of the structures formed by EPD may be dependent on the size and shape of the electrodes. It would be desirable to form large regions of patterned depositions or electroplated material with fine features on any conductive or photoconductive surface. Known solutions for forming three dimensional structures over a large area with small defined features by EPD or electroplating have been elusive.

It has been shown recently that photoconductive electrodes and patterned light can be used to dynamically control electric fields. Various embodiments described herein advance both EPD and electroplating to arbitrarily pattern multiple two dimensional (2D) and three dimensional (3D) composites over large areas of an arbitrary conductive surface with very small feature sizes (for example, sub-100 μm). The following embodiments describe systems that use a light to locally control the electric field, and use moveable electrodes, thereby mitigating the need for expensive single-use electrodes. In order to pattern large areas, the following embodiments describe systems and methods to locally control the electric field by moving the light delivery while forming large area structures. Various embodiments described herein include the following examples of moving the deposition electrode and/or photoconductive electrode, and/or selectively directing light, but these examples are not meant to limit the embodiments in any way.

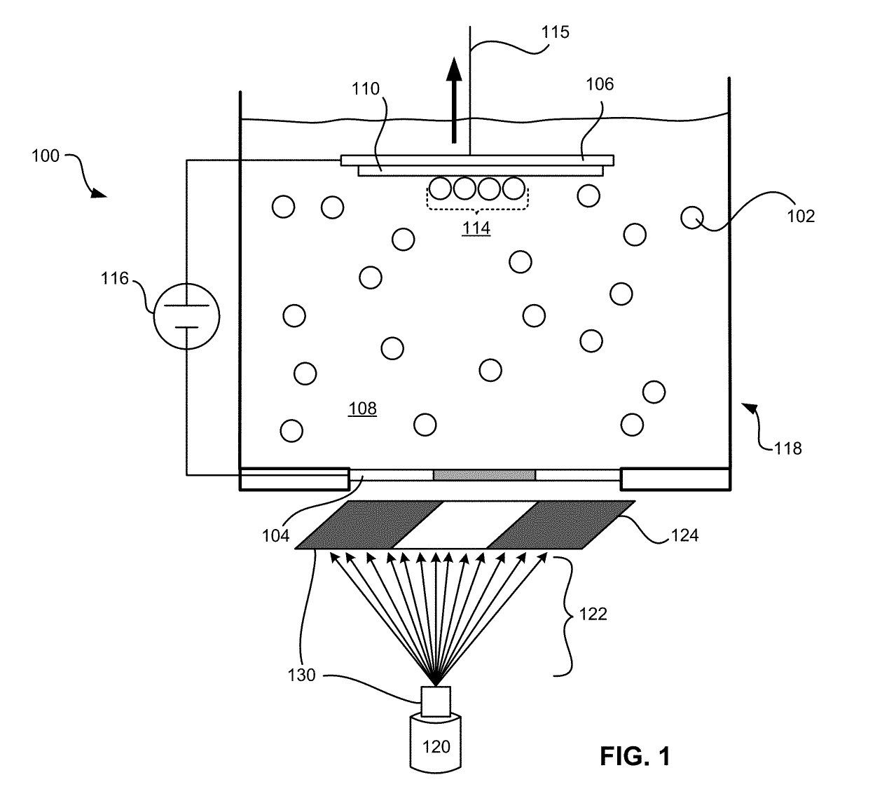

FIG. 1 depicts an EPD device 100 that forms a structure by electrophoretic deposition and/or electroplating in accordance with one embodiment. As an option, the present device 100 may be implemented in conjunction with features from any other embodiment listed herein, such as those described with reference to the other FIGS. Of course, however, such device 100 and others presented herein may be used in various applications and/or in permutations which may or may not be specifically described in the illustrative embodiments listed herein. Further, the device 100 presented herein may be used in any desired environment. It should be noted that the EPD device 100 of FIG. 1 is not drawn to scale, but rather is illustrated to show the features of the present embodiment.

The EPD device 100 may include a movable deposition electrode and/or photoconductive electrode, and/or may selectively alter a light path, to enable generation of structures over larger areas. As shown in FIG. 1, an EPD device 100 may include a first electrode 106 and a second electrode 104 positioned on opposite sides of an EPD chamber 118, with a voltage differential 116 applied across the two electrodes 106, 104 that causes charged nanoparticles 102 in a bath 108 to move toward the first electrode 106 as indicated by the arrow. In some embodiments, a substrate 110 may be placed on a side of the first electrode 106 facing the second electrode 104 such that a layer 114 of nanoparticles 102 may collect thereon.

The EPD device 100, in some embodiments, may be used to deposit materials to the first electrode 106 or to a conductive substrate 110 positioned on a side of the electrode 106 facing the second electrode 104 and exposed to a bath 108 including the nanoparticles 102 to be deposited. By controlling certain characteristics of formation of structures in an EPD process, such as the precursor material composition (e.g., homogenous or heterogeneous nanoparticle solutions) and orientation (e.g., non-spherical nanoparticles), deposition rates (e.g., by controlling an electric field strength, using different solvents, etc.), particle self-assembly (e.g., controlling electric field strength, particle size, particle concentration, temperature, etc.), material layers and thicknesses (e.g., through use of an automated sample injection system and deposition time), and deposition patterns with each layer (e.g., via use of dynamic electrode patterning), intricate and complex structures may be formed using EPD processes that may include a plurality of densities, microstructures, and/or compositions, according to embodiments described herein.

Equation 1 sets out the basic system-level model for electrophoretic deposition, where W_{film} is the mass of the deposition layer, μ is the electrophoretic mobility, E is the electric field, A is the area of the electrode substrate, C is the deposition particle mass concentration, and t is the deposition time.

W_{film}=∫^{t2}ₜ₁μE A C dt Equation 1

Combining these principles with dynamic patterning and sample delivery (which is described in more detail later), electrophoretic deposition may be employed to produce a diverse set of products with unique and/or difficult to obtain shapes, designs, and properties custom-fitted to any of a number of practical applications.

In one approach, EPD technology may be combined with pattern-oriented deposition in order to effectuate complex two- and three-dimensional patterning structures. In another approach, coordinating sample injection during EPD further enables complex patterning of structures of a deposited material in complex two- and three-dimensional arrangements.

As illustrated in FIG. 1, the mechanism 130 for directing light is positioned near the photoconductive electrode 104. Therefore, the light 122 from the light source 120 passes through the mechanism 130 for directing light prior to reaching the photoconductive electrode 104. The mechanism 130 for directing light may include one or more mirrors, one or more lenses, and/or any other mechanism 130 for directing light that would become apparent to one of skill in the art upon reading the present description.

Note that the mechanism 130 for directing light may provide one or more patterns to the light 122 (e.g. to alter the light 122 from the light source 120), e.g., via one or more filters, or one or more patterned screens 124, or one of any other mechanism for patterning light that would become apparent to one of skill in the art upon reading the present description. In some approaches, the light directed by the mechanism for directing light may illuminate the photoconductive electrode through a mask, a raster graphics image, a grid of pixels, a bitmapped display, etc. In other approaches, the dimensions of the light illuminated on the photoconductive electrode may be pixel width; a beam; in the shape of a square, oval, rectangle, etc.; etc.

Dynamic altering of the light 122 may be greatly enhanced, for example, the mechanism 130 for directing light may be programmed to change over time to allow light 122 to reach the photoconductive electrode 104 according to a patterned screen 124.

In various embodiments, following electrophoretic deposition of a layer 114 of nanoparticles 102 on the substrate 110, the actuator arm 115 of the deposition electrode 106 may move the deposition electrode 106 in the direction of the arrow a distance of about the width of one layer 114 of nanoparticles 102, thereby setting the deposition electrode 106 into position for deposition of a second layer of nanoparticles above the first layer 114 of nanoparticles 102.

In another approach, multiple materials may be combined during patterning by way of coordinated sample injection in order to effectuate complex electrochemical and structural arrangements. By way of example, this approach may be employed to accomplish sample doping or to form ceramics or composites, such as ceramic metals (cermets). During some approaches that involve the deposition of different materials on a single layer, the actuator arm 115 of the deposition electrode 106 may not move until deposition of all materials for a specific image or pattern for a single layer 114 of nanoparticles 102 is complete.

Similarly, multiple dynamic patterns may be overlaid in combination with dynamic sample injection during the EPD process to generate a layered structure having differing arrangements, densities, microstructures, and/or composition according to any number of factors, including preferences, application requirements, cost of materials, etc.

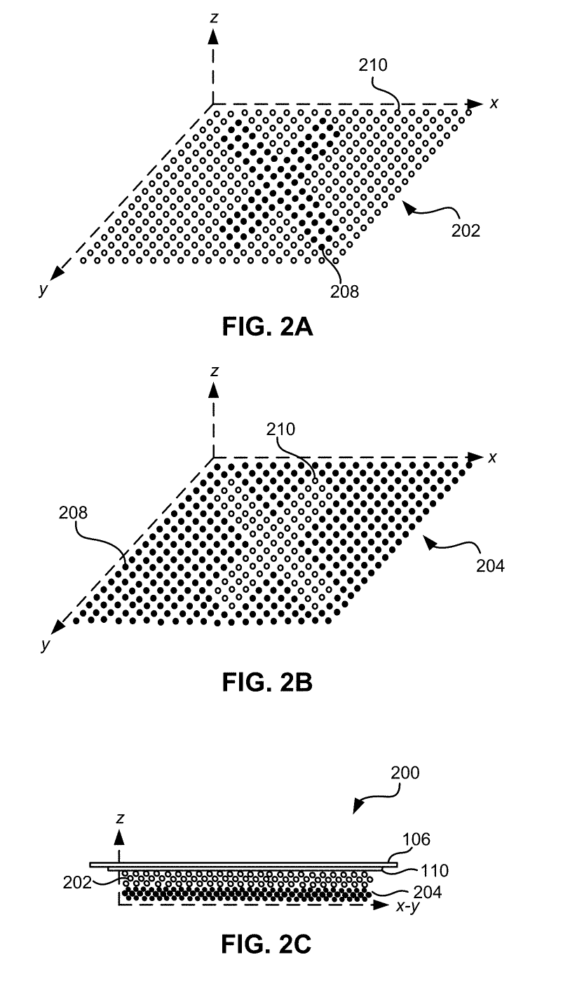

Now referring to FIGS. 2A-2C, according to one embodiment, a first layer 202 having a composition, microstructure and/or density in an x-y plane oriented parallel to a plane of deposition of the first layer 202.

As shown in FIG. 2A, the x-y plane is represented in an isometric view of a simplified schematic diagram of a single layer 202, which is represented by a plurality of black dots of a first material 208 and a plurality of white dots of a second material 210. The dots of the first material 208 may represent a density of the layer, a composition of the layer, a microstructure of the layer, etc. in which light was directed on photoconductive electrode according to an inverse pattern of an X such that the deposition of particles of the first material 208 deposited on the deposition electrode in the pattern surrounding an X.

Of course, the embodiments described herein are not meant to be limiting on the invention in any way. Also, the patterns are not limited to those shown in FIGS. 2A and 2B, and may include any shape (polygonal, regular, irregular, etc.), repeating pattern (single pixels, lines, shapes, areas, etc.), random array, etc.

In another embodiment, at least the first material 208 and/or the first layer 202 may have a characteristic of being deposited through an EPD process according to the first pattern. This characteristic may include, in some embodiments, smooth, gradual gradients between the materials in the first layer 202, abrupt transitions from the first material 208 to the second material 210 in the first layer 202, regular patterning between the first material 208 and the second material 210, or any other characteristic of deposition through an EPD process as would be understood by one of skill in the art upon reading the present descriptions. In a further embodiment, at least the first material 208 may have a characteristic of being deposited through the EPD process above a non-planar electrode. For example, the non-planar electrode may have a cylindrical shape, a regular polygonal shape, a conical shape, a curved surface shape, or any other non-planar shape, as would become apparent one of skill in the art upon reading the present descriptions.

With continued reference to FIG. 2A, in another embodiment, the first material 208 (black dots) may be deposited through an EPD process according to an X pattern of light directed on the photoconductive electrode such that the X pattern on the first layer 202 is deposited with black dots of the first material 208. Moreover, a second material may be deposited after the first material is deposited. In some approaches, the bath of the EPD chamber is changed to a composition of the second material 210 where a pattern of the inverse of an X pattern of light is directed on the photoconductive electrode such that the inverse of an X pattern is deposited with the second material 210 onto the first layer 202 having the pattern of the X deposited with the first material 208 on the deposition electrode as illustrated in FIG. 2A.

According to one embodiment as shown in FIG. 2B, the structure 200 may further comprise a second layer 204 above the first layer 202, wherein the deposition electrode may be moved in a z direction before deposition of the second layer so that the distance between the most recent deposited layer and the photoconductive electrode may remain constant. The second layer 204 may have a composition, microstructure and/or density in an x-y plane oriented parallel to a plane of deposition of the first layer 202.

In another embodiment, at least the first material 208, the second material 210 and/or the second layer 204 may have a characteristic of being deposited through an EPD process according to a second pattern. For example, as shown in FIG. 2B, the first material 208 may be deposited on the second layer 204 above the first layer 202 according to light directed to a pattern of the inverse of an X on the photoconductive electrode. Then the second material 210 may be deposited according to the light directed to a pattern of an X on the photoconductive electrode as illustrated in FIG. 2B.

In a further embodiment, at least the first material, the second material and/or the second layer may have a characteristic of being deposited through the EPD process above a non-planar electrode, as described previously.

According to another embodiment, as shown in FIG. 2C, a 3D structure may be formed using EPD and/or electroplating on a substrate 110 on the deposition electrode 106. Various embodiments involve depositing a second layer 204 on to the first layer 202 such that the layers are ordered in the z direction perpendicular to the x-y plane. As shown in FIG. 2C, the composition of the first layer 202 may be repeated for multiple layers (as shown as 3 sub-layers of white dots representing a single edge of the second material 210 in layer 202) and the composition of the second layer 204 may be repeated for multiple layers (as shown as 3 sub-layers of black dots representing a single edge of the first material 208 on the layer 204). For deposition of each sub-layer, the actuator arm 115 (as shown in device 100, FIG. 1) may move the deposition electrode the distance of about the width of the sub-layer so that the distance between the newly formed layer and the photoconductive electrode remains constant during formation of the structure.

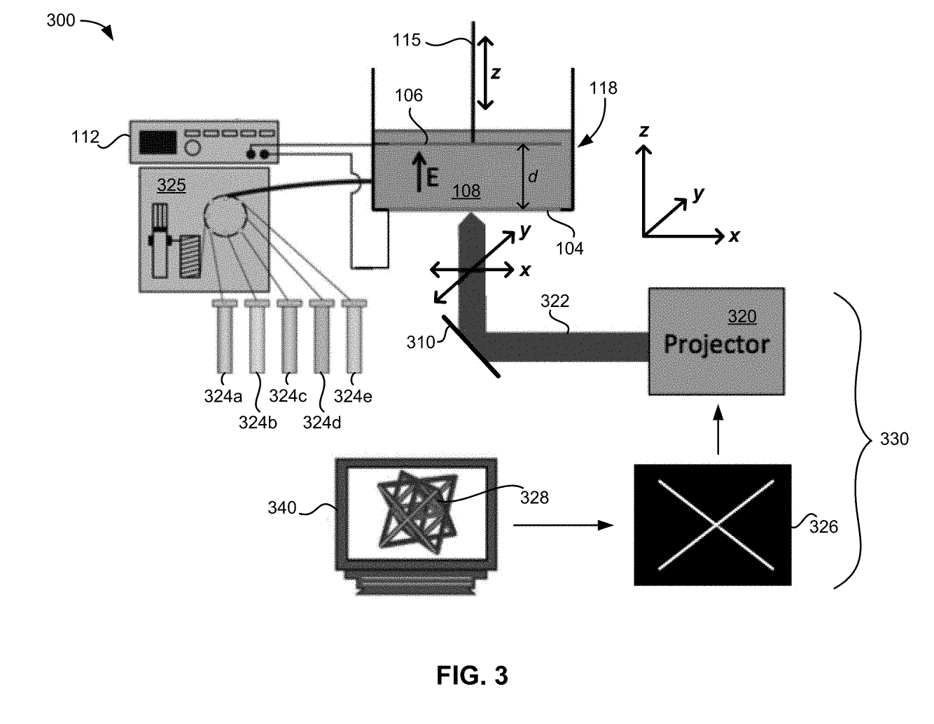

FIG. 3 depicts a system 300 to produce fine featured patterned 2D parts or 3D parts over large areas with multiple materials using electrophoretic deposition and electroplating in accordance with one embodiment. As an option, the present system 300 may be implemented in conjunction with features from any other embodiment listed herein, such as those described with reference to the other FIGS. Of course, however, such system 300 and others presented herein may be used in various applications and/or in permutations which may or may not be specifically described in the illustrative embodiments listed herein. Further, the system 300 presented herein may be used in any desired environment.

In one embodiment of system 300 as illustrated in FIG. 3, a system includes a deposition electrode 106, where the deposition electrode 106 may be configured to move in a z direction. Moreover, the deposition electrode may be configured to move during deposition. The system includes a counter electrode 104, where the deposition electrode 106 and the counter electrode 104 may be positioned in a chamber and may be oriented opposite from one another. In one approach, the deposition electrode and counter electrode may be vertically opposed in the chamber. In another approach, the deposition electrode and counter electrode may be horizontally opposed in the chamber. In yet another approach, the deposition electrode 106 may be at the top of the chamber 118, while the counter electrode 104 is at the bottom, as illustrated in FIG. 3. In yet other approaches, the deposition electrode may be at the bottom of the chamber and the counter electrode positioned at the top of the chamber. In each of these approaches, the electrodes 104, 106 may be submerged in the bath 108 so that an electric field E is created in the bath 108 between the electrodes 104, 106.

In various embodiments, the counter electrode 104 may be a photoconductive electrode. In some embodiments, the photoconductive electrode 104 may include photoconductive materials, for example, but not limited to, amorphous zinc oxide, titanium dioxide, etc.

In one embodiment, the photoconductive layer on the photoconductive electrode may be positioned between a transparent or semi-transparent electrode and the deposition electrode, wherein portions of the photoconductive layer become conductive in response to light impinging thereupon.

In one example, a photoconductive electrode 104 may include glass coated with transparent conductive oxide film, e.g., fluorine doped tin oxide. Furthermore, a photoconductive material, e.g. titanium dioxide, may be grown above the coated glass to form an electrical complex that may be conductive when exposed to light.

In some embodiments, the deposition electrode 106 may include conductive material, for example, but not limited to, aluminum, copper, graphite, etc.

In a preferred embodiment of system 300 as illustrated in FIG. 3, the deposition electrode 106 and the photoconductive electrode 104 may be large and extend across most of each respective side of the chamber. For example, the photoconductive electrode may be a large sheet and the mechanism for delivering light may move an image across the sheet thereby causing deposition of particles onto the deposition electrode according to the pattern of the image on the photoconductive electrode.

The system 300 also includes a mechanism 330 for directing a light onto the photoconductive electrode 104. The mechanism 330 may be configured to move the light in an x direction and/or a y direction, where the x direction is oriented perpendicular to the y direction and x-y directions are in a plane that is perpendicular to the z direction.

In various embodiments, the mechanism for directing light may be configured to deliver light at a wavelength to cause photoconductive material of the photoconductive electrode to create a change in the electric field according to the pattern illuminated on the photoconductive electrode. In one embodiment, the photoconductive electrode may be comprised of a layer of titanium dioxide nanorods hydrothermally grown on a fluorine doped tin oxide film previously deposited onto a glass substrate. The light delivery mechanism might then use 405 nm light to activate the photoconductive material.

As illustrated in FIG. 3, in one embodiment, the mechanism 330 for directing light may be configured to generate light 322 based on a pattern of a layer 326 from a 3D model 328, where the 3D model 328 may be sliced into single layers corresponding to layers to be deposited on the deposition electrode 106. Furthermore, the mechanism for directing light may be configured as described for the mechanism 130 in FIG. 1.

With continued reference to FIG. 3, a 3D model 328 may be constructed to describe the layers and the patterns of each layer via computer modeling using known techniques, according to various embodiments.

In some embodiments, the mechanism 330 for directing light 322 might be sending a single image, a portion of a single image, a dynamic image that is changing during deposition, etc. For example, the layers might be slices, gradients, patterns, etc. In other approaches, the mechanism 330 for directing light 322 may move the light according to a mirror 310, according to a projector 320 that illuminates a single image, according to a projector that illuminates different parts of an image, according to a projector 320 that illuminates a changing image during deposition, e.g. a movie of the layer, etc.

According to one embodiment, system 300 also includes a chamber where the chamber contains a solution. As shown in FIG. 3, the chamber 118 contains a bath 108 that may be a composition of a particle suspension in solution 324a, ion solution 324b, other solutions 324c, 324d, 324e, etc. The bath 108 may also include a solvent of conventional type. In some approaches, the photoconductive electrode 104 may be a side of the chamber 118. In other approaches, the photoconductive electrode 104 may inside the chamber 118.

In one embodiment of system 300, a bath changer 325 of conventional design may be configured to control a composition of a bath 108 in the chamber 118, where the bath changer 325 may be configured to create the composition of the bath 108. In some approaches the composition of the bath may include a particle suspension in solution 324a. In other approaches, the composition of the bath may include an ion solution 324b. In yet other approaches, the composition of the bath may include a mixture of solutions, for example two different particle solutions 324a and 324c.

In one embodiment of system 300, the deposition electrode 106 may be submerged in the bath 108 of the chamber 118.

According to one embodiment, the system 300 includes a power source 112 for applying a voltage differential across the electrodes 106, 104. In some approaches the voltage differential may create an electric field E to cause electrophoretic deposition of particles from a solution 324a in a bath 108 to the deposition electrode 106 in a pattern determined by the photoconductive electrode 104. In other approaches, the voltage differential may create a current to cause electroplating of metal ions in a solution 324b in the bath 108 to deposit metal ions on the deposition electrode 106. The electroplating is localized to the regions of illumination because only those currently illuminated regions are conductive and allow current to flow.

According to various embodiments of system 300, the deposition electrode 106 may be configured to be a pre-defined distance d from the photoconductive electrode 104 where the deposition electrode 106 may be configured move in the z direction in steps about equal to the thickness of each deposited layer after deposition of the respective layer such that a pre-defined distance d from the photoconductive electrode 104 may be maintained. Moreover, the deposition of each subsequent layer may occur substantially at the pre-defined distance d from the photoconductive electrode 104. In some approaches, the pre-defined distance d may be less than about 1 mm and greater than 0 mm.

According to one embodiment, system 300 includes a controller 340 configured to generate a pattern of a layer from a 3D model 328 sliced into single layers 326 and configured to move the deposition electrode 106 according to the pattern determined by the layer 326 of the 3D model 328. Note that functions such as pattern generation, mirror control, electrode control, etc. in this and/or other embodiments may be performed by a single controller, or multiple controllers.

Various embodiments described herein present a system in which the photoconductive electrode may be small in size and may move in two directions x and y in a plane. One of the advantages of using a smaller photoconductive electrode is the photoconductive electrode may move across the plane of the deposition electrode and illuminate the pattern of the layer to allow EPD or electroplating across a large area of the deposition electrode. In cases where the material for the photoconductor electrode is scarce or expensive, it would be desirable to have a system in which the photoconductor electrode is small to minimize expense.

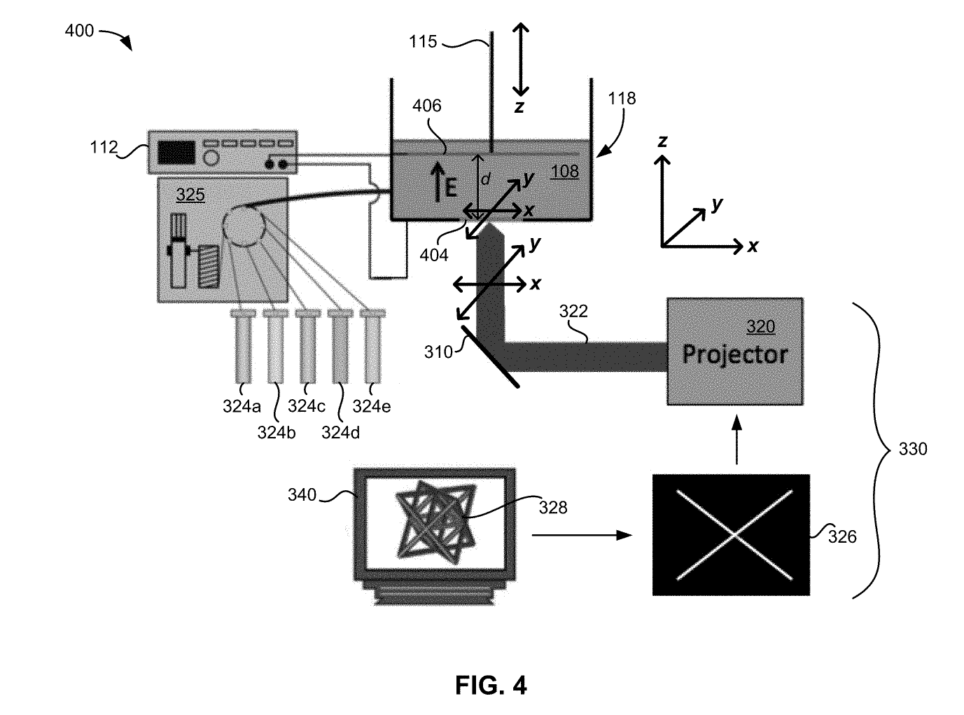

FIG. 4 depicts a system 400 to produce fine featured patterned 2D parts and/or 3D parts over large areas with multiple materials using electrophoretic deposition and electroplating in accordance with one embodiment. As an option, the present system 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

According to one embodiment, system 400 includes a deposition electrode 406, where the deposition electrode may be configured to move in a z direction. Moreover, the deposition electrode may be configured to move during deposition. The system includes a counter electrode 404, where the deposition electrode 406 and the counter electrode 404 may be positioned in a chamber and may be oriented opposite from one another. In various embodiments, the counter electrode 404 may be a photoconductive electrode.

In some approaches, the photoconductive electrode 404 of system 400 may be smaller than the deposition electrode 406, as an example but not to limit in any way, the photoconductive electrode 404 may be a size as small as 90% smaller than the deposition electrode 406.

In an exemplary embodiment of system 400, the photoconductive electrode 104 may be configured to move in the x direction and/or y direction, where the mechanism 330 for directing the light 322 onto the photoconductive electrode 404 may be configured to cause the light to follow the movement of the photoconductive electrode 404. In various embodiments, the mechanism for directing light may be configured as described in FIGS. 1 and 3.

In some approaches, the mechanism 330 for directing the light may be configured to cause light 322 to follow the movement of the photoconductive electrode 404 for continuous deposition across an area. In another approach, the mechanism 330 for directing the light may be configured to locate a position of the photoconductive electrode 404, then directs light 322 onto the photoconductive electrode 404 when it is at the position.

In various embodiments of system 400, a mechanism 330 for directing a light 322 onto the photoconductive electrode 404 may be configured to move the light 322 in an x direction and/or a y direction, where the x direction is oriented perpendicular to the y direction and x-y directions are in a plane that is perpendicular to the z direction.

Furthermore, system 400 includes a chamber 118, where the chamber 118 may contain bath 108 to which one or more solutions 324a, 324b, 324c, etc. are added.

According to one embodiment, the system 400 includes a power source 112 for applying a voltage differential across the electrodes 406, 404. In some approaches the voltage differential may create an electric field E to cause electrophoretic deposition of particles from a solution 324a in a bath 108 to the deposition electrode 406 in a pattern determined by the photoconductive electrode 404. In other approaches, the voltage differential may create a current to cause electroplating of metal ions in a solution 324b in the bath 108 to deposit metal ions on the deposition electrode 406.

According to various embodiments of system 400, the deposition electrode 406 may be configured to be a pre-defined distance d from the photoconductive electrode 404 where the deposition electrode 406 may be configured move in the z direction in steps of which each step may be about equal to the thickness of each deposited layer after deposition of the respective layer such that a pre-defined distance d from the photoconductive electrode 404 may be maintained. Moreover, the deposition of each subsequent layer may occur substantially at the pre-defined distance d from the photoconductive electrode 404. In some approaches, the pre-defined distance d may be less than about 1 mm and greater than 0 mm.

Various embodiments described below provide a system in which the photoconductive electrode may be small and fixed in one position and the deposition electrode may be large and may move in three directions: x and/or y direction for forming a layer and a z direction for moving the deposition electrode a pre-defined distance from the photoconductive electrode. As described below the mechanism for shining the light on the photoconductive electrode may be configured to direct the light onto the photoconductive electrode in one spot. The image of a single layer that is patterned onto the photoconductive electrode may be constantly changing over the fixed photoconductive electrode in concert with the deposition electrode which moves in the x and/or y direction during deposition according to the image directed on the photoconductive electrode.

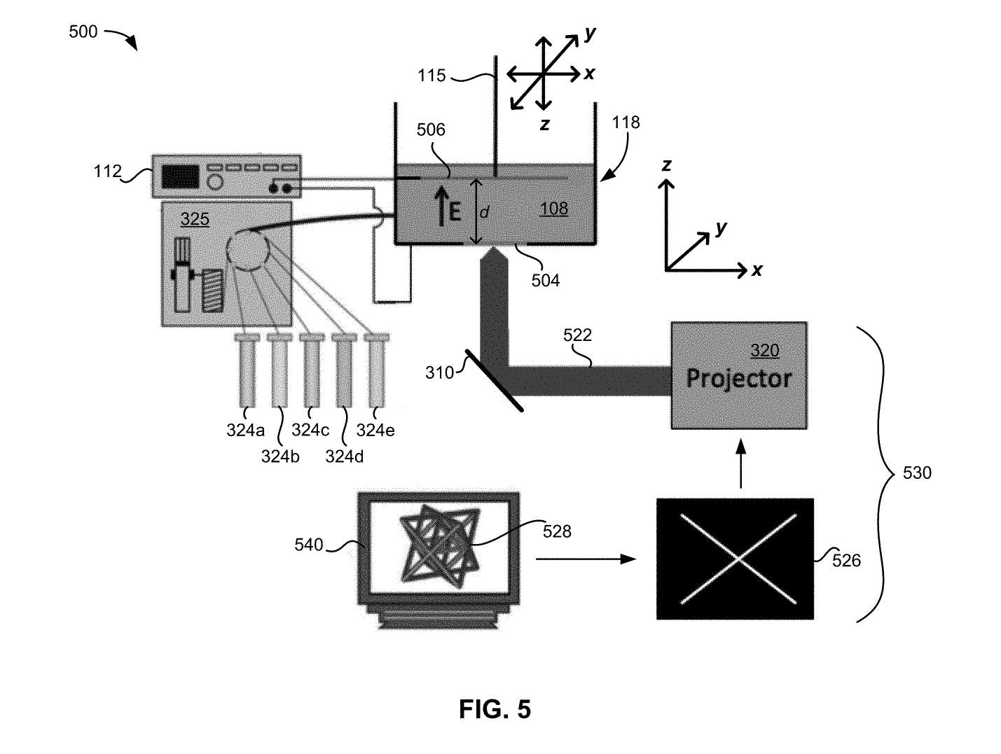

FIG. 5 depicts a system 500 to produce fine featured patterned 2D parts and/or 3D parts over large areas with multiple materials using electrophoretic deposition and electroplating in accordance with one embodiment. As an option, the present system 500 may be implemented in conjunction with features from any other embodiment listed herein, such as those described with reference to the other FIGS. Of course, however, such system 500 and others presented herein may be used in various applications and/or in permutations which may or may not be specifically described in the illustrative embodiments listed herein. Further, the system 500 presented herein may be used in any desired environment.

According to one embodiment, system 500 includes a deposition electrode 506, where the deposition electrode may be configured to move in an x direction and/or a y direction, where the x direction is oriented perpendicular to the y direction and the x-y directions are in a plane that is perpendicular to the z direction. In some approaches, the deposition electrode 506 may be configured to move during deposition.

According to various embodiments, system 500 includes a counter electrode 504, where the deposition electrode 506 and the counter electrode 504 may be positioned in a chamber and may be oriented opposite from one another. Moreover, the counter electrode 504 may be a photoconductive electrode.

Furthermore, the counter electrode 504 may be a photoconductive electrode and may be fixed in place, for example but not limited to, as part of the chamber 118. In some approaches, the photoconductive electrode 504 of system 500 may be smaller than the deposition electrode 506, as an example but not to limit in any way, the photoconductive electrode 504 may be a size as small as 90% smaller than the deposition electrode 506.

Various embodiments of system 500 include a mechanism 530 for directing a light 522 onto the photoconductive electrode 504 where the mechanism may be configured to direct light 522 on a fixed photoconductive electrode 504. In some approaches, the mechanism 530 may direct light 522 on a single spot of the fixed photoconductive electrode 504.

Furthermore, system 500 includes a chamber 118, where the chamber 118 may contain a bath 108 to which one or more solutions 324a, 324b, 324c, etc. may be added. In some approaches, system 500 includes a bath changer 325 configured to control a composition of a bath in the chamber, where the bath changer may be configured to create the composition of the bath 108.

According to one embodiment, the system 500 includes a power source 112 for applying a voltage differential across the electrodes 506, 504. In some approaches the voltage differential may create an electric field E to cause electrophoretic deposition of particles from a solution 324a in a bath 108 to the deposition electrode 506 in a pattern determined by the photoconductive electrode 504. In other approaches, the voltage differential may create a current to cause electroplating of metal ions in a solution 324b in the bath 108 to deposit metal ions on the deposition electrode 506.

According to one embodiment, system 500 includes a controller 540 configured to generate a pattern of a layer from a 3D model 528 sliced into single layers 526 and configured to move the deposition electrode 506 according to the pattern determined by the layer 526 of the 3D model 528.

According to various embodiments of system 500, the deposition electrode 506 may be configured to be a pre-defined distance d from the photoconductive electrode 504 where the deposition electrode 506 may be configured move in the z direction in steps of which each step may be about equal to the thickness of each deposited layer after deposition of the respective layer such that a pre-defined distance d from the photoconductive electrode 504 may be maintained. Moreover, the deposition of each subsequent layer may occur substantially at the pre-defined distance d from the photoconductive electrode 504. In some approaches, the pre-defined distance d may be less than about 1 mm and greater than 0 mm.

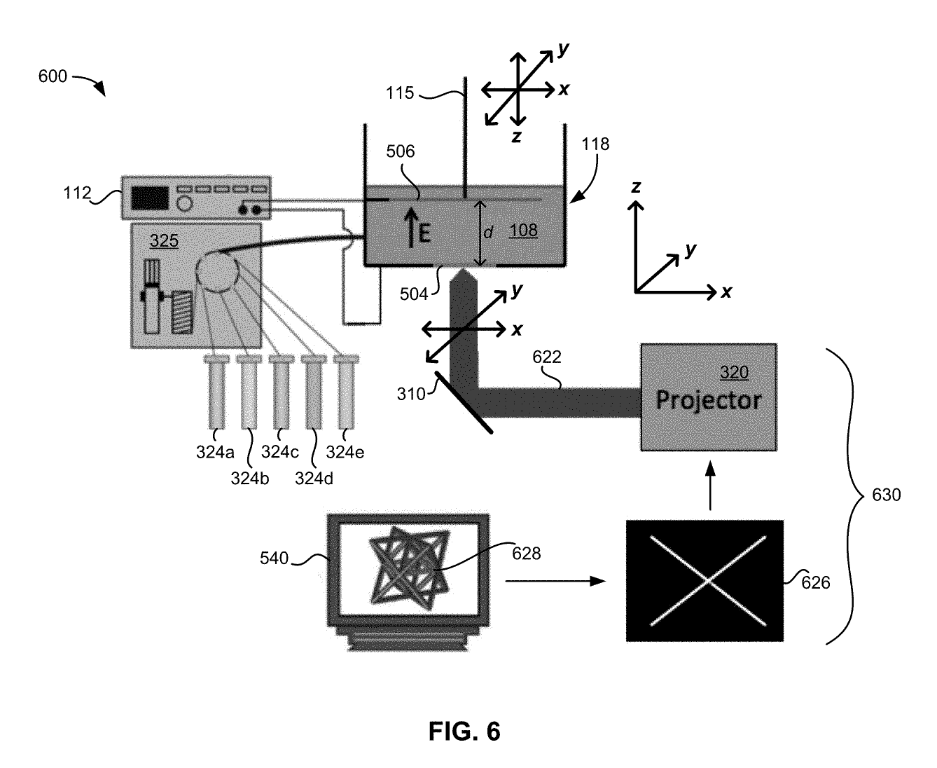

FIG. 6 depicts a system 600 to produce fine featured patterned 2D parts and/or 3D parts over large areas with multiple materials using electrophoretic deposition and electroplating in accordance with one embodiment. As an option, the present system 600 may be implemented in conjunction with features from any other embodiment listed herein, such as those described with reference to the other FIGS. Of course, however, such system 600 and others presented herein may be used in various applications and/or in permutations which may or may not be specifically described in the illustrative embodiments listed herein. Further, the system 600 presented herein may be used in any desired environment.

According to one embodiment, system 600 includes a deposition electrode 506, where the deposition electrode may be configured to move in an x direction and/or a y direction, where the x direction is oriented perpendicular to the y direction and the x-y directions are in a plane that is perpendicular to the z direction. In some approaches, the deposition electrode 506 may be configured to move during deposition.

According to various embodiments, system 600 includes a counter electrode 504, where the deposition electrode 506 and the counter electrode 504 may be positioned in a chamber and may be oriented opposite from one another. Moreover, the counter electrode 504 may be a photoconductive electrode.

According to some embodiments of a system 600 as illustrated in FIG. 6, the mechanism 630 for directing light may be configured to generate a direction of light 622 based on a pattern of a layer 626 from a 3D model 628 sliced into single layers. In some approaches, the mechanism 630 for directing light 622 may be configured to move the light 622 in an x direction and/or a y direction, where the x direction is oriented perpendicular to the y direction and x-y directions are in a plane that is perpendicular to the z direction.

According to various embodiments of system 600, the deposition electrode 506 may be configured to be a pre-defined distance d from the photoconductive electrode 504 where the deposition electrode 506 may be configured move in the z direction in steps of which each step may be about equal to the thickness of each deposited layer after deposition of the respective layer such that a pre-defined distance d from the photoconductive electrode 504 may be maintained. Moreover, the deposition of each subsequent layer may occur substantially at the pre-defined distance d from the photoconductive electrode 504. In some approaches, the pre-defined distance d may be less than about 1 mm and greater than 0 mm.

Other components shown in FIGS. 3, 4, 5, and 6 of the EPD systems 300, 400, 500 and 600 not specifically described herein may be chosen, selected, and optimized according to any number of factors, such as in size limitations, power requirements, formation time, etc., as would be known by one of skill in the art.

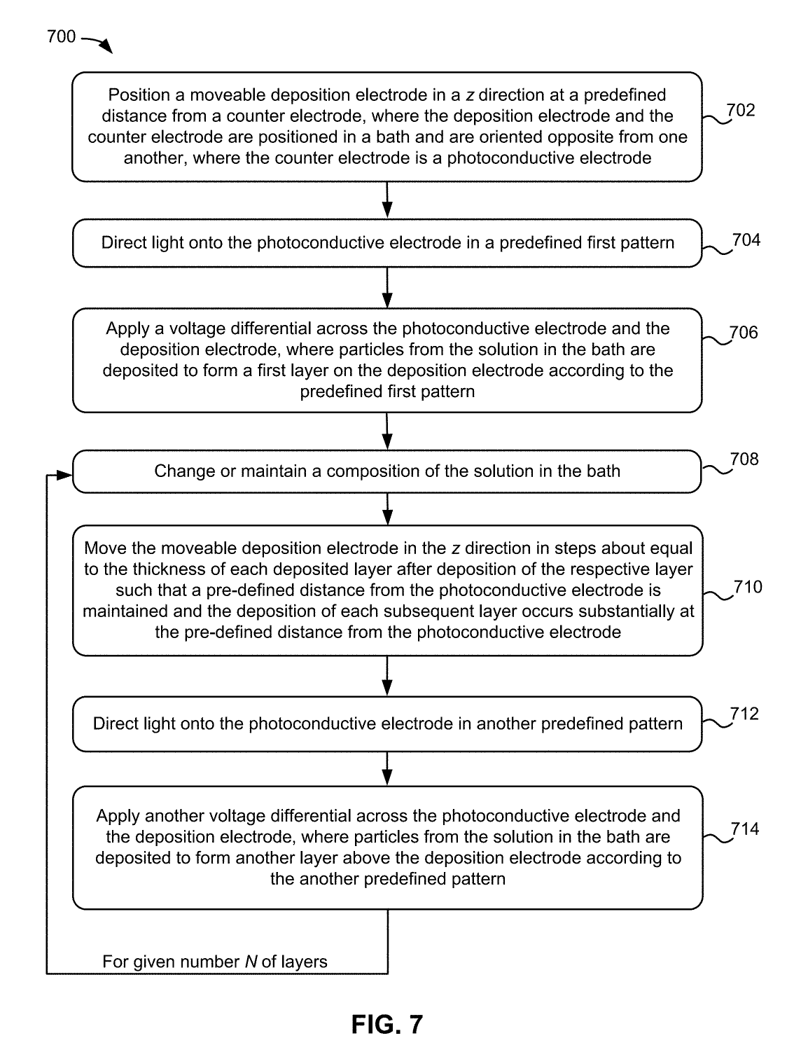

Now referring to FIG. 7, a method 700 for fabricating a 3D model of different materials is shown in accordance with one embodiment. As an option, the present method 700 may be implemented to methods such as those shown in the other FIGS. described herein. Of course, however, this method 700 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 6 may be included in method 700, according to various embodiments. It should also be noted that any of the aforementioned features may be used in any of the embodiments described in accordance with the various methods

According to one embodiment, the method 700 for fabricating a 3D model of different materials begins with operation 702 which involves moving a moveable deposition electrode in a z direction at a pre-defined distance from a counter electrode, where the deposition electrode and the counter electrode may both be positioned in a bath and may be oriented opposite from one another. Moreover, the counter electrode may be a photoconductive electrode.

According to some embodiments (for example, system 500 illustrated in FIG. 5 and system 600 in FIG. 6), operation 702 may involve positioning the deposition electrode in an x direction and/or a y direction, wherein the x direction is oriented perpendicular to the y direction and the x-y directions are in a plane that is perpendicular to the z direction.

Referring back to FIG. 7, operation 704 of method 700 involves directing light onto the photoconductive electrode in a pre-defined first pattern, while applying a voltage differential across the photoconductive electrode and deposition electrode in operation 706. The concurrent illumination of operation 704 and application of the voltage differential of operation 706 induce deposition on the deposition electrode in alignment with the illuminated areas of the photoconductive electrode.

According to some embodiments of method 700, operation 704 of directing light onto the photoconductive electrode may involve moving the light in a pre-defined pattern determined by a layer of the 3D model. In some embodiments (for example, systems 300, 400, and 600 illustrated in FIGS. 3, 4, and 6, respectively), operation 704 may further involve moving the light in an x direction and/or a y direction, where the x direction may be oriented perpendicular to the y direction and x-y directions are in a plane that may be perpendicular to the z direction.

In one embodiment of method 700 (for example, system 400 as illustrated in FIG. 4), operation 704 of directing light onto the photoconductive electrode may involve the light following the movement of the photoconductive electrode. In some approaches of method 700, operation 704 may include after moving the deposition electrode in the z direction, moving a moveable photoconductive electrode in an x direction and/or a y direction, wherein the x direction is oriented perpendicular to the y direction and the x-y directions are in a plane that is perpendicular to the z direction. In other approaches, operation 704 of directing light onto the photoconductive electrode may involve moving the light according to the movement of the photoconductive electrode followed by applying the light onto the photoconductive electrode in a pre-defined pattern. In yet other approaches, a combination of the foregoing may be performed.

In operation 706 of method 700, a voltage differential may be applied across the photoconductive electrode and the deposition electrode. Moreover, particles from the solution in the bath may be deposited to form a first layer on the deposition electrode according to the predefined first pattern. According to one embodiment as illustrated in FIG. 1, the voltage differential 116 is applied in the direction (black arrow) toward the deposition electrode 106. Any method may be used for applying the voltage difference to form an electric field that causes charged particles in the solution, such as a first material, to move toward an oppositely charged electrode. For sake of simplicity, in this description, the charged particles migrate toward the deposition electrode.

According to one embodiment, method 700 involves repeating for a given number N of layers of the 3D model the following operations N-1 times.

Operation 708 of method 700 involves changing or maintaining a composition of a solution in the bath. Looking to FIG. 3, in some approaches, a bath changer 325 may change the composition in the bath 108 from having a first solution 324a to a composition including another solution, e.g., 324b, or a mixture of solutions, such as solution 324a, 324b, 324c, etc. In other approaches, the first solution 324a of the bath may be maintained for the deposition of the second layer on the deposition electrode 106. The solutions 324a, 324b, 324c, etc. may have particles, metal ions, etc. in an aqueous or organic solution.

In another embodiment, the method 700 may further comprise expelling the aqueous or organic solution having the first material from the EPD chamber prior to introducing the aqueous or organic solution having the second material into the EPD chamber. In this way, more abrupt transitions from the electrophoretically deposited first material to the electrophoretically deposited second material may be made, whereas slowly introducing the second material (such as in a solution having the second material therein) into the EPD chamber while the first solution is still present may result in more gradual transitions from the first material to the second material (for example, with a first material of ceramic and a second material of metal).

Operation 710 of method 700 includes moving the moveable deposition electrode in the z direction in steps about equal to the thickness of each deposited layer after deposition of the respective layer such that a pre-defined distance from the photoconductive electrode is maintained and the deposition of each subsequent layer occurs substantially at the pre-defined distance from the photoconductive electrode.

Operation 712 of method 700 includes directing light onto the photoconductive electrode in another pre-defined (first, second, or next) pattern. Operation 714 of method 700 includes applying another voltage differential across the photoconductive electrode and the deposition electrode while the light simultaneously illuminates the photoconductive electrode, whereby particles from the solution in the bath are deposited to form another layer above the deposition electrode according to the presently-applied pre-defined pattern (first, second, or next). Note that the presently-applied voltage differential could be the same or different as that applied in operation 706, e.g., to adjust a rate of deposition.

In some approaches of operation 714, the deposition may include electrophoretic deposition. In other approaches the bath may be composed of a solution of metal ions whereby metal ions from the solution may be electroplated onto the deposition electrode in a pre-defined pattern according to the light directed onto the photoconductive electrode. Thus, in this approach of operation 714, the deposition may include electroplating. In yet other approaches of operation 714, the deposition operation may include both electrophoretic deposition and electroplating.

According to various embodiments of method 700, electrophoretic deposition and electroplating may only occur on the deposition electrode in regions of illumination directed onto the photoconductive electrode and will only occur when a voltage differential is applied at the same time light is incident on the photoconductive material.

In use, this invention may be used as a method of manufacturing parts with fine features and multiple materials over large areas. Potential applications include patterned functionally graded parts, electrodes, circuits, sensors, etc.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method for fabricating a three-dimensional (3D) model of different materials, comprising:
positioning a moveable deposition electrode at a pre-defined distance from a counter electrode, wherein the deposition electrode and the counter electrode are positioned in a bath and are oriented opposite from one another, wherein the counter electrode is a photoconductive electrode;
directing light onto the photoconductive electrode in a pre-defined first pattern while simultaneously applying a voltage differential across the photoconductive electrode and the deposition electrode, whereby particles from a solution in the bath are deposited to form a first layer on the deposition electrode according to the pre-defined first pattern; and
repeating, for a given number N of layers of the 3D model, the following operations N-1 times:
changing or maintaining a composition of the solution in the bath,
moving the moveable deposition electrode in a z direction in steps about equal to a thickness of each deposited layer after deposition of the respective layer such that a pre-defined distance from the photoconductive electrode is maintained and a deposition of each subsequent layer occurs substantially at the pre-defined distance from the photoconductive electrode,
directing light onto the photoconductive electrode in another pre-defined pattern while simultaneously applying another voltage differential across the photoconductive electrode and the deposition electrode, whereby particles from the solution in the bath are deposited to form another layer above the deposition electrode according to another pre-defined pattern.

2. A method as recited in claim 1, wherein directing light onto the photoconductive electrode includes moving the light in a pre-defined pattern determined by a layer of the 3D model.

3. A method as recited in claim 2, wherein directing light onto the photoconductive electrode includes moving the light in an x direction and/or a y direction, wherein the x direction is oriented perpendicular to the y direction and x-y directions are in a plane that is perpendicular to the z direction.

4. A method as recited in claim 1, comprising after moving the deposition electrode in the z direction, moving a moveable photoconductive electrode in an x direction and/or a y direction, wherein the x direction is oriented perpendicular to the y direction and x-y directions are in a plane that is perpendicular to the z direction.

5. A method as recited in claim 4, wherein directing light on the photoconductive electrode includes the light following the movement of the photoconductive electrode.

6. A method as recited in claim 4, wherein directing light onto the photoconductive electrode includes moving the light according to the movement of the photoconductive electrode followed by applying the light onto the photoconductive electrode in a pre-defined pattern.

7. A method as recited in claim 1, wherein the deposition includes electrophoretic deposition.

8. A method as recited in claim 1, wherein the deposition includes electroplating.

9. A method as recited in claim 1, wherein deposition operations include both electrophoretic deposition and electroplating.

10. A method as recited in claim 1, further comprising moving the deposition electrode in an x direction and/or a y direction, wherein the x direction is oriented perpendicular to the y direction and x-y directions are in a plane that is perpendicular to the z direction.

11. The method as recited in claim 1, wherein directing light onto the photoconductive electrode comprises directing the light on a single spot of a fixed photoconductive electrode.
